(19) United States
(12) Patent Application Publication
(10) Pub. No.: US 2005/0111150 A1
(43) Pub. Date: May 26, 2005

(54) Electrostatic discharge protection circuit

(75) Inventors: Sheng-Lyang Jang, Taipei (TW); Hsueh-Ming Lu, Hsinchuang City (TW); James Liu, Hsinchu (TW); Jimmy Hsieh, Hsinchu (TW)

Correspondence Address: Cooper & Dunham LLP, 1185 Avenue of the Americas, New York, NY, 10036, US

(73) Assignee: King Billion Electronics Co., Ltd.

(21) Appl. No.: 10/723,732

(22) Filed: Nov. 25, 2003

(51) Int. Cl. H02H 9/00

(52) U.S. Cl. 361/56

(57) ABSTRACT

An ESD protection circuit is disclosed, including a silicon controlled switch (SCS), a switch control circuit, a metal oxide semiconductor field effect transistor (MOSFET), and a transistor control circuit, wherein when terminal over-voltage stress occurs over the positive power supply terminal in the active mode, the transistor control circuit is able to turn on the MOSFET, and at the same time the switch control circuit is able to trigger the SCS into conduction to form a discharging path, such that the terminal voltage over the positive power supply terminal will be rapidly decreased to the level of the holding voltage of the SCS to provide ESD protection for the IC. When terminal over-voltage stress in the active mode is removed, the MOSFET is disabled, but the SCS remains closed for discharge current, so the latch-up phenomenon is avoided.

### BACKGROUND OF THE INVENTION

1. Field of the Invention

The present invention is related to an electrostatic discharge (ESD) protection circuit, in particular to a circuit that is capable of providing ESD having a metal oxide semiconductor field effect transistor (MOSFET) coupled onto a silicon controlled switch (SCS) so as to switch the silicon controlled switch (SCS) to a conductive state to create a discharging path.

2. Description of Related Art

An integrated circuit (IC) or semiconductor device is generally susceptible to electrostatic discharge (ESD), which is a discharge current for a short duration in which a large amount of current is passed onto the device. The electrostatic charges may come from the human body. The voltage difference between the body and the device will produce a spike when the human body makes contact with the device. This short circuit carrying high voltage may damage the internal circuit of the device if it is not provided with ESD protection.

Many schemes have been implemented to protect an IC from ESD. Two of the commonly used circuit designs for ESD protection are used for discussion here.

The first scheme uses an insulated-gate metal oxide semiconductor field effect transistor (MOSFET) to build the ESD protection circuit. When ESD occurs, the metal oxide semiconductor field effect transistor (MOSFET) will be enabled, and then the parasitic bipolar junction transistor (BJT) will be triggered into conduction to form a discharging path. When ESD is terminated, the metal oxide semiconductor field effect transistor (MOSFET) will be disabled. The advantage of using such design for the protection circuit design is that the protection circuit is able to operate with no latch-up problem, that is because the holding voltage is usually greater than the terminal voltage over the positive power supply terminal V_{DD} when the ESD is terminated, so the latch-up will never occur. However, the disadvantage is that the discharge rate of electrostatic charges is unsatisfactory.

Latch-up is an abnormal phenomenon that occurs when a current path is created between the positive and negative power supply nodes in a semiconductor device. A low-resistance path can pass current at high voltage levels that exceed the tolerance of the circuit. Consequently, such large currents can cause malfunction of the circuit and permanent damage to the circuit.

The second scheme, as shown in FIG. 7, is to use a silicon controlled switch (SCR) (70) (SCR) between the positive power supply terminal V_{DD} and the ground terminal V_{SS} to build the ESD protection circuit. When ESD occurs, a high voltage will appear over the positive power supply terminal V_{DD} coupled with a resistor (71), which will cause the silicon controlled switch (SCR) (70) to be forward biased and triggered into conduction, so that a discharging path is formed between the positive power supply terminal V_{DD} and the ground terminal V_{SS} for providing electrostatic discharge protection.

Comparing with other ESD protection circuits, the discharge rate of the above circuit using the silicon controlled switch (SCR) (70) is the best. Since the ESD protection circuit using a silicon controlled switch (SCR) can provide effective ESD protection for IC components, circuit designers often use this scheme to create an ESD protection circuit in IC components. Nevertheless, this control circuit unfortunately requires a higher trigger voltage, which poses a limitation on its applications.

To solve the high trigger voltage problem, many types of modified circuits have been proposed. One such scheme, shown in FIG. 8, is a silicon controlled rectifier (SCR) circuit (LVTSCR) that uses low voltage to trigger the silicon controlled rectifier (SCR) into conduction. Another one, as shown in FIG. 9, uses low voltage gate coupled silicon controlled rectifier (SCR) circuit (GCSCR). Still another one, shown in FIG. 10, uses a diode array to trigger the silicon controlled rectifier (SCR) circuit (DCTSCR). A final one, as shown in FIG. 11, uses a Zener diode to trigger the silicon controlled rectifier (SCR) circuit (ZDTSCR). The above-mentioned ESD protection circuits disclosed have lowered the trigger voltage, but the latch-up problem still remains.

The ESD protection circuit shown in FIG. 9 has an NPN transistor of the silicon controlled rectifier (SCR) (70) and the field effect transistor connected in parallel, and the gate electrode is connected to an RC circuit. In certain operation conditions, when the terminal over-voltage stress occurs in the active mode, even though the gate coupled silicon controlled rectifier (SCR) can operate with a lower trigger voltage, the circuit still needs an appropriate RC circuit for controlling the conduction time. It is possible that the silicon controlled rectifier (SCR) will remain in latch-up after the transient state is terminated, and the SCR may also fail in countering the DC over-voltage stress. These are the disadvantages of using this scheme.

The ESD protection circuit, shown in FIG. 10, uses a diode array to trigger the silicon controlled rectifier (SCR) into conduction. This scheme is not only able to use a lower trigger voltage, it can also offer protection against over-voltage stress in both active and inactive modes of the IC. However, the leakage current from the diode array D1-D4 in the forward bias is a serious problem.

The ESD protection circuit, shown in FIG. 11, uses a Zener diode to trigger the silicon controlled rectifier (SCR) circuit into conduction. This scheme has the advantage of a lower trigger voltage for the silicon controlled rectifier (SCR) circuit like the diode array mentioned above, and it offers protection against terminal over-voltage stress in both active and inactive modes, but it has the weakness of needing a longer time to enter the conduction stage.

From the foregoing, the above schemes have provided different modifications for the ESD protection circuit, nevertheless the conventional silicon controlled rectifier (SCR) circuit still has the problems of leakage current, high trigger voltage, low holding voltage, and latch-up problem; and the MOSFET circuit still has the problems of poor discharge rate and using too much space in the circuit.

### SUMMARY OF THE INVENTION

The main object of the present invention is to provide an ESD protection circuit that is characterized by a low trigger voltage, high discharge rate and no latch-up problem, so that the IC can be operated with higher reliability and efficiency.

To this end, the ESD protection circuit, in accordance with the present invention, is composed of:
a silicon controlled switch (SCS) being installed between the positive and negative power supply nodes;
a switch control circuit being installed between the positive power supply terminal and the gate electrode of the silicon controlled switch (SCS);
a metal oxide semiconductor field effect transistor (MOSFET) being connected to the emitter of a parasitic transistor in the silicon controlled switch (SCS) to control the breakover of the SCR in the active and inactive modes; and
a transistor control circuit being installed between the positive power supply terminal and the metal oxide semiconductor field effect transistor (MOSFET).

Using the above structure, when the terminal forward over-voltage stress occurs in the active mode, the transistor control circuit outputs a sufficiently high voltage to cause the metal oxide semiconductor field effect transistor (MOSFET) to be enabled, and at the same time the switch control circuit produces an avalanche current or other trigger current for triggering the silicon controlled switch (SCS) into conduction, thus a discharging path is created. Since the silicon controlled switch (SCS) remains in a conduction state, the terminal voltage over the positive power supply terminal will decrease rapidly to the level of the holding voltage of the silicon controlled switch (SCS) for ESD protection. This circuit design has the advantages of using a lower trigger voltage to increase the efficiency of ESD protection.

The above mentioned silicon controlled switch (SCS) is formed by an NPN transistor and a PNP transistor, wherein the PNP transistor uses the emitter to act as the first anode of the SCR, and the collector coupled to the base of the NPN transistor, and the base of the PNP transistor coupled to the collector of the NPN transistor to act as the gate electrode of the SCR.

The above mentioned metal oxide semiconductor field effect transistor (MOSFET) has the drain coupled to the emitter of the NPN transistor in the silicon controlled switch (SCS), and the gate electrode coupled to the transistor control circuit.

The above mentioned transistor control circuit is formed by a capacitor and a resistor, wherein the circuit junction is coupled to the gate electrode of the metal oxide semiconductor field effect transistor (MOSFET), such that through adjustment of the capacitor and resistor values the time constant of the RC circuit can be determined, for use in controlling the conduction time of the metal oxide semiconductor field effect transistor (MOSFET), so as to give sufficient time for reducing the terminal over-voltage stress in the active mode to the minimum. The circuit function is to control the conductive state of the MOSFET and the conduction time.

The above mentioned transistor control circuit can be built with other circuits with equivalent functions.

The above switch control circuit is created with a Zener diode connected across the base electrodes of complementary PNP/NPN transistors in the silicon controlled switch (SCS), so that the discharge current can continue after the metal oxide semiconductor field effect transistor (MOSFET) is disabled. This transistor control circuit may be replaced by other circuits with equivalent circuit functions.

In the above mentioned switch control circuit, the Zener diode is further connected to a diode in series, so that the Zener diode would not be destroyed when terminal over-voltage stress in a backward direction occurs in the active mode, and the diode can also reduce the leakage current from the Zener diode in a forward direction.

The diode array is connected in series in series between the silicon controlled switch (SCS) and the ground terminal, so that when the terminal over-voltage stress in the active mode is removed, the silicon controlled switch (SCS) can remain in the conductive state, and the diode array can also boost the holding voltage in the inactive mode for ESD protection.

The above mentioned diode array may be connected between the positive power supply terminal and the silicon controlled switch (SCS).

Other objectives, advantages and novel features of the invention will become more apparent from the following detailed description when taken in conjunction with the accompanying drawings.

### BRIEF DESCRIPTION OF THE DRAWINGS

FIG. 1 is a system block diagram of the present invention;

FIG. 2 is a schematic diagram of the circuit design in the first embodiment of the invention;

FIG. 3 is a schematic diagram of the circuit design in the second embodiment of the invention;

FIG. 4 is a schematic diagram of the circuit design in the third embodiment of the invention;

FIG. 5 is a schematic diagram of the circuit design in the fourth embodiment of the invention;

FIG. 6 is a schematic diagram of the circuit design in the fifth embodiment of the invention;

FIG. 7 is the schematic diagram of a conventional silicon controlled switch (SCS) ESD protection circuit;

FIG. 8 is the schematic diagram of a low trigger voltage silicon controlled switch (SCS) ESD protection circuit;

FIG. 9 is the schematic diagram of a low trigger voltage gate coupled conventional silicon controlled switch (SCS) ESD protection circuit;

FIG. 10 is a diode array trigger conventional silicon controlled switch (SCS) ESD protection circuit; and

FIG. 11 is a Zener diode trigger conventional silicon controlled switch (SCS) ESD protection circuit.

### DETAILED DESCRIPTION OF THE PREFERRED EMBODIMENT

The present invention can be implemented through three preferred embodiments with slightly different structures. These three preferred embodiments will now be described with reference to the accompanying drawings.

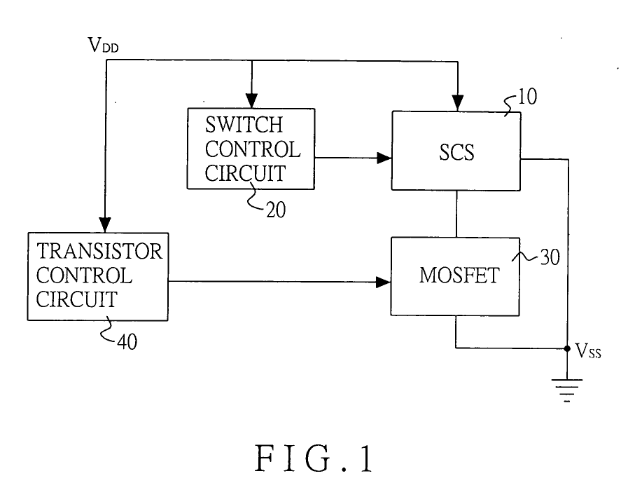

With reference to FIG. 1, the basic structure of the ESD protection circuit, in accordance with the present invention, comprises a silicon controlled switch (SCS) (10), a switch control circuit (20), a metal oxide semiconductor field effect transistor (MOSFET) (30), and a transistor control circuit (40).

The silicon controlled switch (SCS) (10) is connected between the positive power supply terminal of V_{DD} and ground terminal V_{SS}.

The switch control circuit (20) is connected between the positive power supply terminal V_{DD} and the gate electrode of the silicon controlled switch (SCS) (10).

The metal oxide semiconductor field effect transistor (MOSFET) (30), denoted by Q1, is connected to the silicon controlled switch (SCS) (10) to control the breakover of the silicon controlled switch (SCS) (10).

The transistor control circuit (40) is installed between the positive power supply terminal V_{DD} and the metal oxide semiconductor field effect transistor (MOSFET) (30). The circuit function is to control the conduction of the MOSFET (30) and the conduction time.

When the terminal over-voltage stress occurs on the positive power supply terminal V_{DD}, the above mentioned transistor control circuit (40) outputs a sufficiently high voltage pulse to the metal oxide semiconductor field effect transistor (MOSFET) (30) to enable the metal oxide semiconductor field effect transistor (MOSFET) (30), and at the same time the switch control circuit (20) produces an avalanche current to cause the silicon controlled switch (SCS) (10) to be triggered into conduction to form a discharging path. Since the silicon controlled switch (SCS) (10) remains in a conduction state, the voltage over the positive power supply terminal V_{DD} will drop rapidly to the level of holding voltage of the silicon controlled switch (SCS), thus providing the ESD protection.

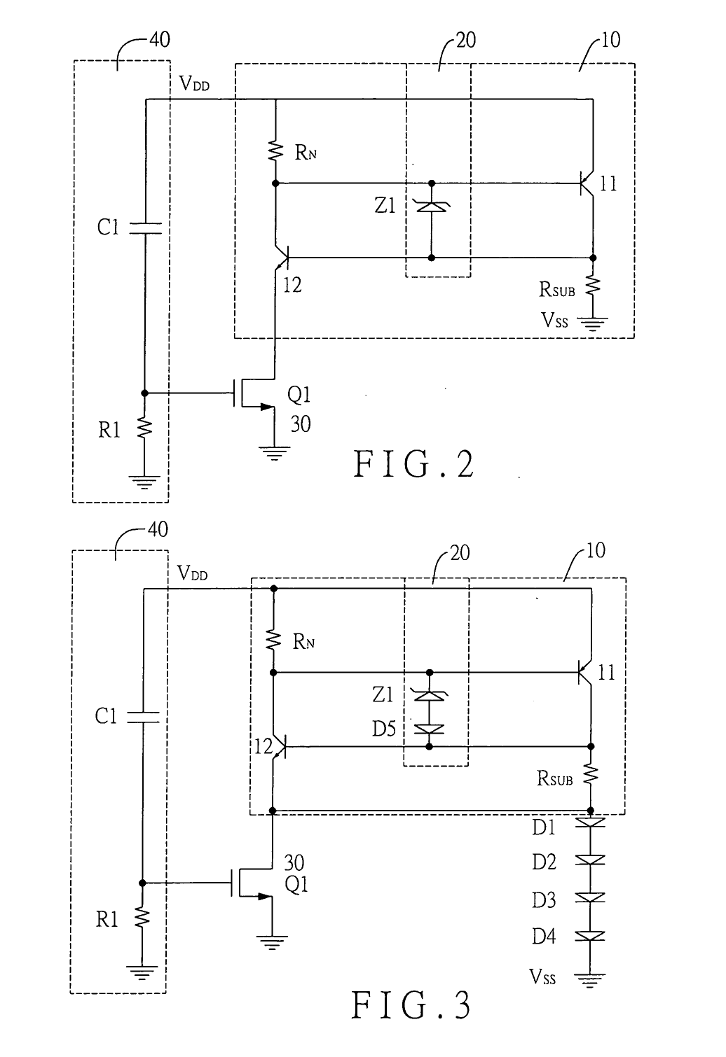

The schematic diagram of the above mentioned circuit is shown in FIG. 2. The silicon controlled switch (SCS) (10) is formed by a PNP transistor (11) and an NPN transistor (12), which can be implemented with bipolar transistors, wherein the PNP transistor (11) uses the emitter to act as a first anode of the SCR, and the base being connected to the positive power supply terminal V_{DD} through a resistor R_{N}, as a second anode of the SCR, and the PNP transistor (11) collector being connected to the base of the NPN transistor (12) and further to the ground terminal V_{SS} through a resistor R_{SUB} as a cathode, and the base of the PNP transistor (11) being connected to the collector of the NPN transistor (12) as a gate electrode of the SCR. The gate electrode is connected to the switch control circuit (20). The complementary parasitic bipolar structures behave like pnpn diodes that are normally reverse biased.

The function of the switch control circuit (20) is to reduce the trigger voltage for the silicon controlled switch (SCS) (10). There are a number of possible implementations for the switch control circuit, such as using the avalanche breakdown on the drain of the metal oxide semiconductor field effect transistor (MOSFET), gate coupled trigger, or Zener diode trigger mechanism. In the present example, the switch control circuit (20) adopts the Zener diode trigger, where the reference voltage is obtained by connecting a Zener diode (Z1) across the base electrodes of complementary PNP/NPN transistors (11)/(12) in the silicon controlled switch (SCS) (10), and the other end of the Zener diode (Z1) is connected to the positive power supply terminal V_{DD} through a resistor R_{N}.

The above metal oxide semiconductor field effect transistor (MOSFET) (30) is cascaded to the silicon controlled switch (SCS) (10) to form the ESD protection circuit. In the present example, the drain of the above metal oxide semiconductor field effect transistor (MOSFET) (30) is connected in series to the emitter of the NPN transistor (12) in the silicon controlled switch (SCS) (10).

Also, in the present example, the transistor control circuit (40) is formed by a RC circuit, wherein one end of resistor R1 is connected to the negative power supply terminal V_{SS}, and the other end linked to capacitor C1 through a node, which is connected to the gate electrode of metal oxide semiconductor field effect transistor (MOSFET) (30). The time constant of the RC circuit can be determined by adjusting the values of resistor R1 and capacitor C1, so as to control the conduction time of the metal oxide semiconductor field effect transistor (MOSFET) (30).

The circuit structure used in the present invention has been explained above, and the circuit action to provide ESD protection is to be explained below.

When the forward over-voltage stress occurs in the active mode over the positive power supply terminal V_{DD}, the transistor control circuit (40) outputs a sufficiently high voltage signal to enable the metal oxide semiconductor field effect transistor (MOSFET) (30), and at the same time the switch control circuit (20) produces an avalanche current to cause the silicon controlled switch (SCS) (10) to be triggered into conduction, thus a discharging path is formed. Since the silicon controlled switch (SCS) (10) remains in conduction, the voltage over the positive power supply terminal V_{DD} will drop rapidly to the level of holding voltage of the silicon controlled switch (SCS) (10), thus providing the ESD protection for the IC. When the active mode over-voltage stress is terminated, the output signal of the transistor control circuit (40) will attenuate to the point of being unable to drive the metal oxide semiconductor field effect transistor (MOSFET) (30). At this time one side of the circuit in the silicon controlled switch (SCS) (10) will be open, therefore the latch-up phenomenon will not occur, due to the fact that the holding voltage is larger than the terminal voltage on the positive power supply terminal V_{DD} when the active mode over-voltage stress is terminated.

When the backward over-voltage stress occurs in the active mode on the positive power supply terminal V_{DD}, the transistor control circuit (40) will produce high voltage pulse in the backward direction, so it will be unable to drive the metal oxide semiconductor field effect transistor (MOSFET) (30) into conduction, and part of the silicon controlled switch (SCS) (10) will be switched to a conductive state, so that a discharging path is formed from the ground terminal V_{SS} through the silicon controlled switch (SCS) (10) (from the base to the collector of NPN transistor) to the positive power supply terminal V_{DD}, therefore the present design can provide ESD protection even when the active mode backward over-voltage stress occurs.

Also, when terminal over-voltage stress occurs in the active mode, the transistor control circuit (40) is able to decide the conduction time of the metal oxide semiconductor field effect transistor (MOSFET) (30), which in turn affects the conduction time of the silicon controlled switch (SCS) (10), therefore through appropriate control of the conduction time of the transistor control circuit (40), the effective terminal over-voltage stress in the active mode can be reduced to the minimum if sufficient conduction time is given to the silicon controlled switch (SCS) (10), thus providing the desired results in ESD protection.

Also, when the over-voltage stress is terminated, if high voltage still exists over the positive power supply terminal V_{DD}, then the Zener diode (Z1) can allow the discharge current to continue even after the metal oxide semiconductor field effect transistor (MOSFET) (30) is disabled, because the terminal voltage over the positive power supply terminal V_{DD} is greater than the breakdown voltage of the Zener diode (Z1) to cause the Zener diode (Z1) to switch to a conductive state, so the avalanche current can drive the PNP transistor (11) of the silicon controlled switch (SCS) (10) into the active region, and at this time two discharging paths are formed: the first one is from the positive power supply terminal V_{DD} through the Zener diode (Z1) to the ground terminal V_{SS}, and the second one is from the positive power supply terminal V_{DD} through the PNP transistor (11) to the ground terminal V_{SS}. Since that one side of the circuit in the silicon controlled switch (SCS) (10) through the Zener diode (Z1) remains closed, the discharge current can be continued after the over-voltage stress is terminated.

The second preferred embodiment of the invention is shown in FIG. 3, in which the structure is slightly different from the previous example in that a diode array D1-D4 is connected in series between the silicon controlled switch (SCS) (10) and the ground terminal V_{SS}. The Zener diode (Z1) of the switch control circuit (20) is connected in series to diode D5 installed across the base electrodes of complementary PNP/NPN transistors (11)/(12) in the silicon controlled switch (SCS) (10).

The operation principle of the circuit is similar to the previously explained example, with the exception that, when the discharging path is formed and the active mode over-voltage stress is terminated, the output voltage of the transistor control circuit (40) will be attenuated to the point of being unable to drive the metal oxide semiconductor field effect transistor (MOSFET) (30), but the emitter of NPN transistor (12) in the silicon controlled switch (SCS) (10) is connected in series to the diode array D1-D4, which causes the silicon controlled switch (SCS) (10) to remain in a conductive state, and can also boost the holding voltage in the inactive mode for ESD protection.

As for the diode D5 connected between the Zener diode (Z1) in the switch control circuit (20) and the base of the NPN transistor (12) in the silicon controlled switch (SCS) (10), the presence of the diode D5 not only can protect the Zener diode (Z1) when backward over-voltage stress occurs in the active mode over the positive power supply terminal V_{DD}, but also is able to reduce leakage current from the Zener diode (Z1).

One characteristic of this embodiment over prior art is that the silicon controlled switch (SCS) (10) can be triggered into conduction to provide effective protection notwithstanding that the terminal over-voltage stress occurs in the active or inactive mode. Since the diode array D1-D4 is connected in series to the emitter of the NPN transistor (12) in the silicon controlled switch (SCS) (10), the holding voltage can be significantly boosted to prevent the latch-up phenomenon in both the active mode and inactive modes.

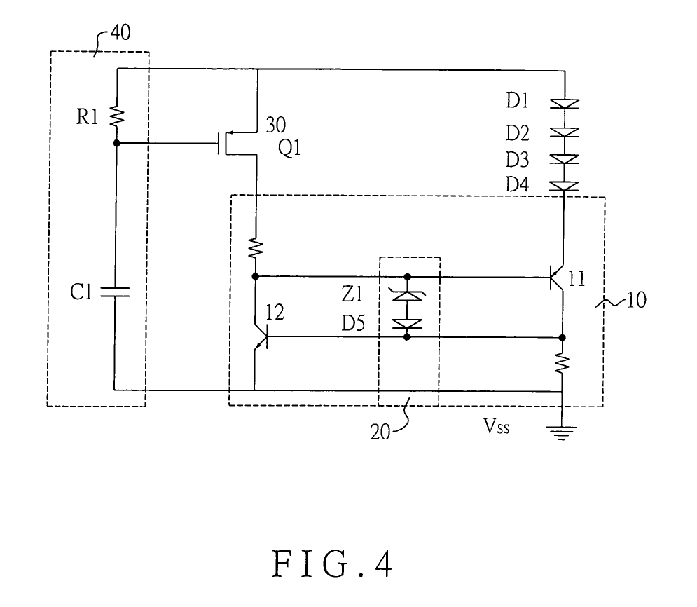

The third embodiment of the invention is shown in FIG. 4, in which the location of the diode array D1-D4 is changed, which is now installed between the emitter of PNP transistor (11) in the silicon controlled switch (SCS) (10) and the positive power supply terminal V_{DD}, and the metal oxide semiconductor field effect transistor (MOSFET) (30) is installed between the positive power supply terminal V_{DD} and the silicon controlled switch (SCS) (10), and yet a similar operation result is obtained. That is, the silicon controlled switch (SCS) (10) can be switched to the conductive state notwithstanding whether the terminal over-voltage stress occurs in the active or inactive mode, and the holding voltage can be boosted to prevent latch-up in the active and inactive modes.

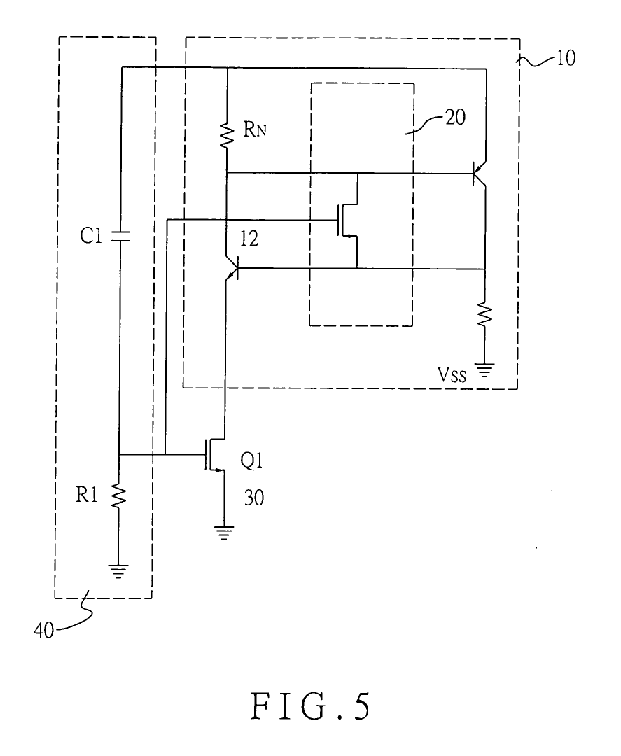

With reference to FIG. 5, the difference between the fourth embodiment and the first embodiment is that the original Zener diode in FIG. 2 is replaced by a NMOS transistor because the NMOS transistor has the superior response capability than the Zener diode. Therefore, the SCS will be rapidly turns to holding state when the terminal over-voltage stress occurs.

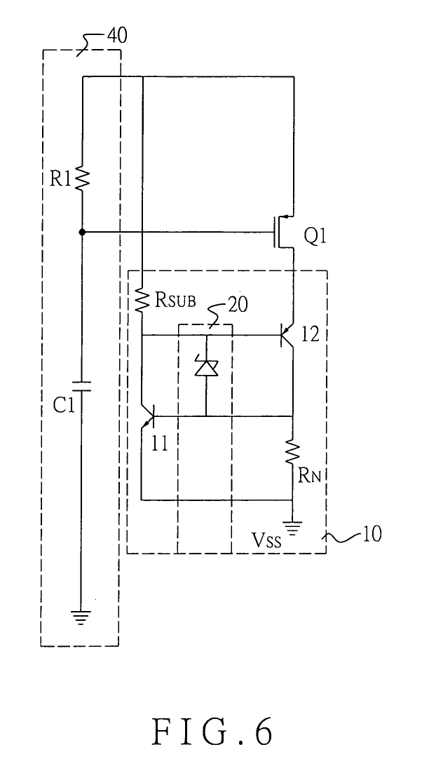

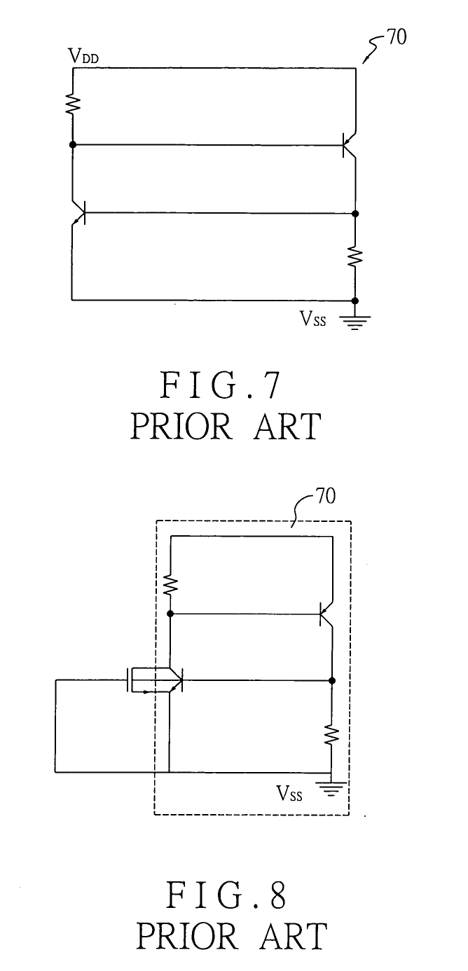

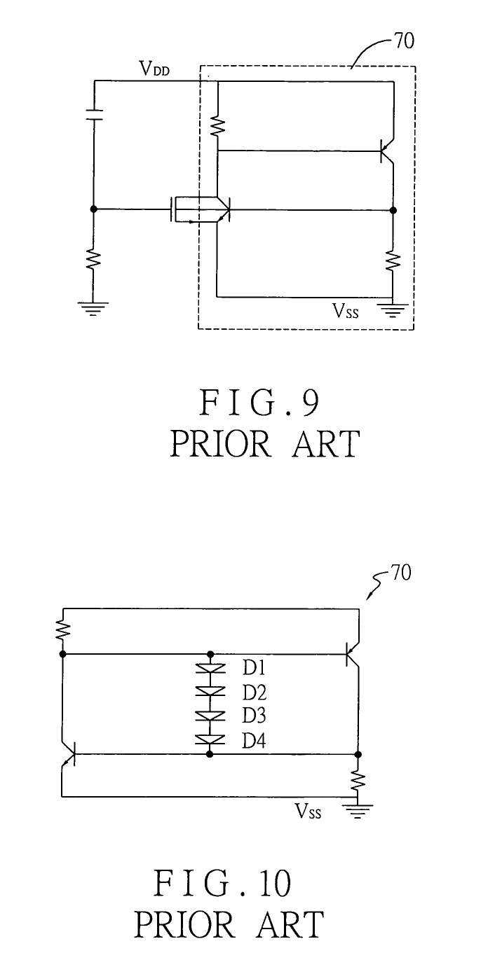

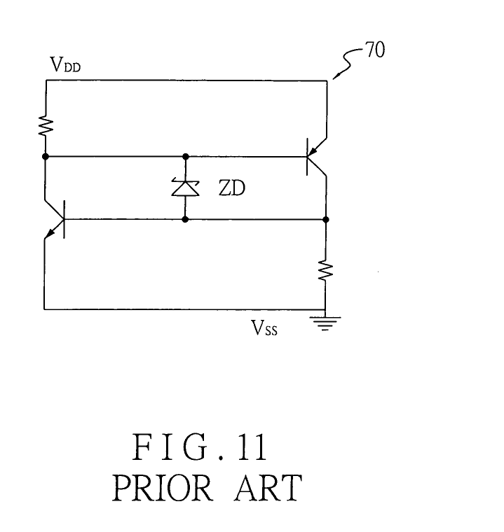

In FIG. 6, a complementary configuration of FIG. 2 is shown, where the NMOS transistor (Q1) in FIG. 2 is replaced with a PMOS transistor (Q1) that is connected to the emitter of the PNP transistor.

In summary, a new method of triggering the silicon controlled switch (SCS) is disclosed in the present invention, wherein the silicon controlled switch (SCS) can be safely switched to a conductive state when the terminal over-voltage stress occurs in the active mode, and the silicon controlled switch (SCS) can be rapidly triggered into conduction to cause terminal over-voltage stress over the positive power supply terminal to decrease rapidly to the level of the holding voltage of the silicon controlled switch (SCS) to provide the ESD protection for the IC. When the over-voltage stress is terminated, the metal oxide semiconductor field effect transistor (MOSFET) is disabled, but since the emitter of NPN transistor in the silicon controlled switch (SCS) is connected in series to the diode array, the silicon controlled switch (SCS) is able to remain in a conductive state notwithstanding whether the terminal over-voltage stress occurs in the active mode or inactive mode, and the holding voltage can be significantly boosted to prevent latch-up in the active and inactive modes.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrostatic discharge (ESD) protection circuit, comprising:
a silicon controlled switch (SCS) installed between positive and negative power supply nodes;
a switch control circuit installed between the positive power supply terminal and the gate of the silicon controlled switch (SCS);
a metal oxide semiconductor field effect transistor (MOSFET) connected to a transistor emitter in the silicon controlled switch (SCS) to cause the silicon controlled switch (SCS) to be triggered into conduction; and
a transistor control circuit installed between the positive power supply terminal and the metal oxide semiconductor field effect transistor (MOSFET);
whereby when the forward over-voltage stress occurs over the positive power supply terminal in the active mode, the transistor control circuit can be enabled to turn on the metal oxide semiconductor field effect transistor (MOSFET), and at the same time the switch control circuit can be enabled to trigger the silicon controlled switch (SCS) into conduction to form a discharging path, such that the terminal voltage over the positive power supply terminal will be rapidly decreased to the level of a holding voltage of the silicon controlled switch (SCS) to provide ESD protection and prevent latch-up of the silicon controlled switch (SCS).

2. The ESD protection circuit as claimed in claim 1, wherein the silicon controlled switch (SCS) is formed by an NPN transistor and a PNP transistor, wherein a first anode of the SCR is formed by an emitter of the PNP transistor, and a second anode of the SCR is formed by a base of the PNP transistor which is connected to the positive power supply terminal through a resistor R_{N}, and a cathode is formed by a collector of the PNP transistor which is connected to a base of the NPN transistor and further through a resistor R_{SUB} to the ground terminal, and a gate is formed by the base of the PNP transistor which is connected to a collector of the NPN transistor.

3. The ESD protection circuit as claimed in claim 1, the transistor control circuit is formed by a capacitor and a resistor, and the capacitor-resistor node is connected to the gate of the metal oxide semiconductor field effect transistor (MOSFET), such that a time constant of the circuit can be determined by adjusting the values of the capacitor and the resistor, so as to control the conduction time of the metal oxide semiconductor field effect transistor (MOSFET).

4. The ESD protection circuit as claimed in claim 2, wherein the switch control circuit has a Zener diode connected across the base electrodes of complementary PNP/NPN transistors in the silicon controlled switch (SCS), so that a discharge current can continue after the metal oxide semiconductor field effect transistor (MOSFET) is disabled.

5. The ESD protection circuit as claimed in claim 4, wherein the Zener diode of the switch control circuit is connected in series by a diode.

6. The ESD protection circuit as claimed in claim 2, wherein the silicon controlled switch (SCS) is connected to the ground terminal through a diode array in series.

7. The ESD protection circuit as claimed in claim 6, wherein the metal oxide semiconductor field effect transistor (MOSFET) is connected between the silicon controlled switch (SCS) and the ground terminal through a drain and a source, and the gate is coupled to the transistor control circuit.

8. The ESD protection circuit as claimed in claim 2, wherein the silicon controlled switch (SCS) is connected to the positive power supply terminal through a diode array in series.

9. The ESD protection circuit as claimed in claim 8, wherein the metal oxide semiconductor field effect transistor (MOSFET) is connected between the positive power supply terminal and the silicon controlled switch (SCS) through a drain and a source, and the gate is coupled to the transistor control circuit.

10. The ESD protection circuit as claimed in claim 2, wherein the switch control circuit has a NMOS transistor connected across the base electrodes of complementary PNP/NPN transistors in the silicon controlled switch (SCS).

11. The ESD protection circuit as claimed in claim 1, wherein the silicon controlled switch (SCS) is formed by an NPN transistor and a PNP transistor, wherein a first anode of the SCR is formed by an emitter of the NPN transistor, and a second anode of the SCR is formed by a base of the NPN transistor which is connected to the negative power supply terminal through a resistor R_{N}, and a cathode is formed by a collector of the NPN transistor which is connected to a base of the PNP transistor, and a gate of the SCR is formed by the base of the NPN transistor which is connected to a collector of the PNP transistor.
